(19) United States
(12) Patent Application Publication
(10) Pub. No.: US 2025/0316249 A1
(43) Pub. Date: Oct. 9, 2025

(54) STRING TENSIONER FOR STRINGED INSTRUMENT

(71) Applicant: Cosmos Lyles, New York, NY (US)

(72) Inventor: Cosmos Lyles, New York, NY (US)

(21) Appl. No.: 19/174,796

(22) Filed: Apr. 9, 2025

Related U.S. Application Data
(60) Provisional application No. 63/631,974, filed on Apr. 9, 2024.

(51) Int. Cl. G10D 3/147; G10D 3/04; G10D 3/12

(52) U.S. Cl. CPC G10D 3/147; G10D 3/04; G10D 3/12

(57) ABSTRACT

A string tensioner for a musical instrument is configured to support an elongated spring beam at a first end so that the spring beam extends proximally from the first end. A second end of the spring beam can be configured to attach to a musical string that is drawn distally from the second end of the spring beam over a saddle and nut. Tension applied to the musical string bends the spring beam, and thus maintains tension in the musical string. A lever arm distance is defined between the first end of the spring beam and the string. As the musical string changes length over an operating range, the degree of bending of the spring beam changes and the lever arm distance also changes so that the tension in the musical string remains substantially the same.

### CROSS-REFERENCE TO RELATED APPLICATION

This application claims priority to U.S. Application No. 63/631,974, which was filed Apr. 9, 2024. The entirety of the priority application is hereby incorporated by reference.

### BACKGROUND

The present disclosure relates to the field of stringed musical instruments, and more particularly to string tensioners for stringed musical instruments.

Various products and applications benefit from holding a wire or string at a near-constant, predictable tension over time and in a variety of environmental conditions. Notably, stringed musical instruments create music by vibrating strings held at tension. If the string is at the correct tension for the given instrument, it will vibrate at a desired frequency corresponding to the desired note. However, musical strings tend to stretch or contract over time and/or due to environmental factors such as temperature, humidity or the like. Such stretching or contracting typically results in the tension in the string changing, and the string thus vibrating at a different frequency than the desired frequency. This can result in the string going out of tune-emitting a note that is aurally different than the desired note. Typical stringed musical instruments tend to go out of tune fairly quickly, and musicians often find themselves spending substantial time tuning their instruments, even in the midst of performances.

### SUMMARY

The present specification discloses method and apparatus for mounting a string of a stringed musical instrument in a manner so that the string remains at a near-constant tension even if the string stretches or contracts over time and/or due to environmental factors. The specification also teaches such a method and apparatus that has a relatively small footprint and can be installed in certain stringed instruments without substantially altering the sound of the instrument, altering its appearance, or interfering with playability.

In some embodiments a string tensioner for a musical instrument can be configured to support an elongated spring beam at a first end so that the spring beam extends proximally from the first end. A second end of the spring beam can be configured to attach to a musical string that is drawn distally from the second end of the spring beam and over a saddle and nut. Tension applied to the musical string bends the spring beam, which bent spring beam maintains tension in the musical string. A lever arm distance is defined between the first end of the spring beam and the string. As the musical string changes length over an operating range the degree of bending of the spring beam changes and the lever arm distance also changes so that the tension in the musical string remains substantially the same.

In accordance with one embodiment the present specification provides a string tensioner for a stringed musical instrument. The string tensioner comprises a tensioner body extending from a base to a spring support, and an elongated spring member having a first end, a second end and a string mount. The string mount is configured to accept a musical string mounted thereon. A spring receiver is disposed in the spring support. The spring receiver is configured to receive the first end of the spring member so that the spring member is held with a flexure portion of the spring member extending proximally from the spring receiver to the string mount. A distally-directed tension force exerted by the musical string on the string mount imposes bending on the spring member.

In some embodiments the spring receiver is configured to be selectively rotatable relative to the tensioner body.

In another embodiment, at a first spring mount position the spring member is deflected a first deflection distance relative to a spring member at-rest position, and the musical string is spaced a first lever arm distance from the string mount, and at a second spring mount position the spring member is deflected a second deflection distance relative to the spring member at-rest position, and the musical string is spaced a second lever arm distance from the string mount.

In some such embodiments, at the first spring mount position the string is held at a first tension and at the second spring mount position the string is held at a second tension, and wherein the note emitted by the musical string at the first tension is within 10 cents of the note emitted by the musical string at the second tension. In further embodiments the note emitted by the musical string at the first tension is within 5 cents of the note emitted by the musical string at the second tension. In still further embodiments the note emitted by the musical string at the first tension is within 10 cents of the note emitted by the musical string at the second tension.

In yet another embodiment the tensioner body comprises a string path cavity aligned with the corresponding string mount, the string path cavity configured to accept the musical string extending therethrough.

A yet further embodiment additionally comprises a bridge assembly. The bridge assembly can comprise a saddle body, a base, and a retainer member. The saddle body can have a string receiver configured to receive a musical string, the saddle body having a pivot edge defined generally opposite the string receiver. The base can be configured to receive the pivot edge so that the saddle body can pivot relative to the base when the pivot edge is engaged with the base. The retainer member can be attached to one of the saddle body and the base. A passage can be formed in the other of the saddle body and the base, the retainer member extending through the passage. The saddle body and the base can be configured so that when the pivot edge is engaged with the base, the retainer member does not restrain pivoting of the saddle body relative to the base.

Another embodiment additionally comprises a blocking surface at or adjacent the passage, wherein the saddle body and the base are configured so that when the saddle body is moved a clearance distance away from the base the retainer member engages the blocking surface in a manner so that the saddle body is blocked from moving farther away from the base.

In accordance with another embodiment, the present specification provides a string tensioner for a stringed musical instrument. The string tensioner can comprise a tensioner body having a support member, a cantilever mount structure, and a rotation limitation assembly. The cantilever mount structure can be attached to the support member in a manner so that the cantilever mount structure is rotatable about the support member. The cantilever mount structure is configured to receive and support a first end of an elongated leaf spring member in a manner so that the elongated leaf spring member extends from the cantilever mount structure. The rotation limitation assembly is configured to engage the cantilever mount structure in a manner so that rotation of the cantilever mount structure about the support member is limited to within an angular range.

In some such embodiments the support member comprises a cylindrical rod and the cantilever mount structure comprises a bore sized to accommodate the rod, and wherein the rod extends through the bore so that the cantilever mount structure rotates about the cylindrical rod. In a further such embodiment, the cantilever mount structure comprises a beam support surface configured so that the first end of the leaf spring member can rest thereon and a fastener configured to secure the first end of the leaf spring onto the beam support surface. In a yet further such embodiment, the tensioner body comprises a cross member having a plurality of spaced-apart threaded tensioner bosses and the cantilever mount structure comprises a tensioner receiver, and an elongated threaded tensioner extends through the tensioner receiver and into the tensioner boss.

A still further embodiment is configured so that advancing the tensioner into the tensioner boss reduces a range of rotation of the cantilever mount structure relative to the support member.

In another embodiment the cantilever mount structure has a longitudinal axis, and the tensioner receiver is spaced from the longitudinal axis.

In yet another embodiment, a spring path is defined in a plane passing through the longitudinal axis of the cantilever mount structure, and wherein the tensioner boss is spaced from the string path.

Some such embodiments additionally comprises a bridge assembly having a saddle, the saddle defining a string receiver aligned with the string path.

### BRIEF DESCRIPTION OF THE DRAWINGS

FIG. 1 shows a schematic representation of a spring and string arrangement;

FIG. 2 shows the arrangement of FIG. 1 in a configuration in which tension is applied to the string;

FIG. 3 shows the arrangement of FIG. 2 in another configuration in which tension is applied to the string;

FIG. 4 is a perspective view of an embodiment of a string tensioner assembly;

FIG. 5 is another perspective view of the arrangement in FIG. 4;

FIG. 6 is a side view of the arrangement in FIG. 4;

FIG. 7 is a top view of the arrangement in FIG. 4;

FIG. 8 is a cross-sectional view taken along line 8-8 of FIG. 7;

FIG. 9 is a view taken along line 9-9 of FIG. 7

FIG. 10 is a cross-sectional view taken along line 10-10 of FIG. 6;

FIGS. 11A-11D are each plan views of an embodiment of a spring beam;

FIG. 12 is a perspective view of an embodiment of a violin tailpiece incorporating an embodiment of a string holder assembly;

FIG. 13 is a side view of another embodiment of a string tensioner;

FIG. 14 is a side view of an arrangement in which a second spring beam has been added;

FIG. 15 is a plan view of another embodiment of a spring beam;

FIG. 16 is a side view of another embodiment of a tension body;

FIG. 17A is a cross-sectional view taken along line 17-17 of FIG. 16;

FIG. 17B shows the arrangement of FIG. 17A with the spring beam of FIG. 15 installed therein;

FIG. 18A is a cross-sectional side view of the spring beam of FIG. 15 disposed within the tension body of FIG. 16;

FIG. 18B shows the configuration of FIG. 18A after tuning;

FIG. 19 shows a cross-sectional side view of another embodiment;

FIG. 20A is a side view of yet another embodiment;

FIG. 20B shows the embodiment of FIG. 20A in a first tuning configuration;

FIG. 20C shows the embodiment of FIG. 20A in a second tuning configuration.

FIG. 21 is a perspective view of another embodiment of a string tensioner assembly;

FIG. 22 is a top view of the string tensioner assembly of FIG. 21;

FIG. 23 is a side view of the string tensioner assembly of FIG. 21;

FIG. 24 is a cross-sectional perspective view taken along line 25-25 of FIG. 22;

FIG. 25 is a cross-sectional side view taken along line 25-25 of FIG. 22;

FIG. 26 shows a portion of the configuration of FIG. 24;

FIG. 27 is a cross-sectional view of a saddle assembly taken along line 27-27 of FIG. 22;

FIG. 28 is a cross-sectional view taken along line 28-28 of FIG. 27;

FIG. 29 is a cross-sectional view taken along line 29-29 of FIG. 27;

FIG. 30 is a cross-sectional view taken along line 30-30 of FIG. 27; and

FIG. 31 shows the arrangement of FIG. 30 with the saddle body pivoting.

### DESCRIPTION

The following description presents embodiments illustrating inventive aspects that are employed in one or more embodiments. It is to be understood that embodiments may exist that are not explicitly discussed herein, but which may employ one or more of the principles described herein. Also, these principles are primarily discussed in the context of stringed musical instruments. However, it is to be understood that the principles described herein can have other applications such as sporting goods and industrial and/or architectural applications in which it may be desired to apply a near-constant force to an item that may move over an operational range.

This disclosure describes embodiments of a device that can apply a near-constant tension to a string, wire or the like even as that string, wire or the like changes in length over a range of distance. Notably, Applicant's U.S. Pat. Nos. 7,855,330 and 10,224,009, which are hereby incorporated by reference in their entireties, teach principles for achieving a near-constant tension in a wire or string as the wire or string expands and/or contracts.

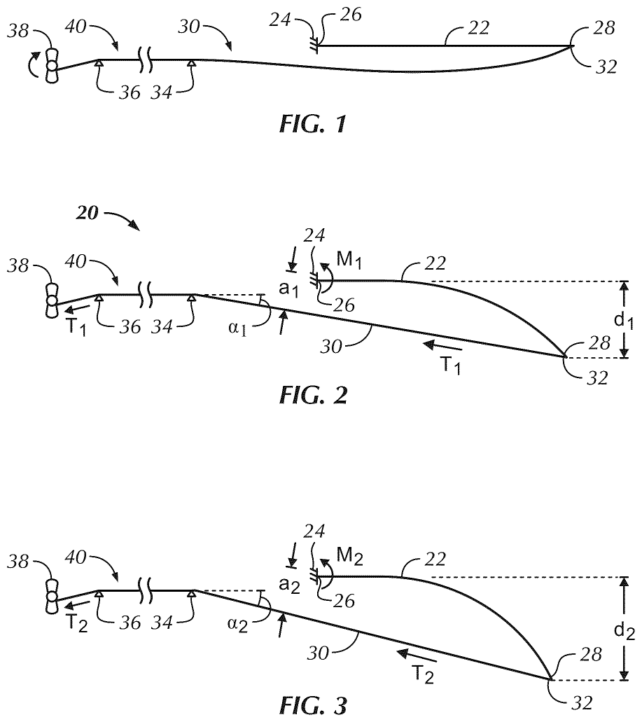

With initial reference to FIGS. 1-3, an embodiment of a spring-based tension device, or tensioner 20, is depicted schematically. In the illustrated embodiment, the tensioner comprises an elongated spring beam 22 extending in a cantilever fashion from a cantilever mount 24. The spring beam 22 preferably is made of a material having advantageous elastic properties, such as spring steel. A supported end 26 of the spring beam 22 is connected at the cantilever mount 24 and extends outwardly therefrom in a proximal direction toward an unsupported end 28. A musical string 30 is attached at a spring mount 32 at or near the unsupported end 28 of the spring beam 22 and is drawn in a distal direction therefrom and over a saddle 34 and nut 36 to a tuning peg 38. The tuning peg 38 is configured to tighten the musical string 30 as typical.

In the schematic illustrations of FIG. 1-3, it is to be understood that the saddle 34, nut 36 and tuning peg 38 are supported on the body of a musical instrument, such as a guitar, that is arranged generally horizontally on the page. As such, the direction vertically up—as used herein—refers to a direction toward the top of the illustrated page, and with reference to a musical instrument such as a guitar, vertically up refers to a direction directly away from the body of the instrument, regardless of the actual orientation in which the instrument may actually be held by a user. Notably, it is also contemplated that the cantilever mount 24 is supported by the body of the instrument.

As the string 30 is tightened, the string 30 will pull distally on the spring beam 22 at the string mount 32, causing the spring beam 22 to deflect downwardly, and imparting a tension T in the string 30 and a reactive torque M at the cantilever mount 24. As depicted in FIG. 2, at a first selected point during tightening of the string 30, a tension T1 is imparted to the string 30, bending the spring beam 22 so that the string mount 32 deflects downwardly a deflection distance d1, and also imparting a moment M1 at the cantilever mount 24. An angle α1 of the string 30 (relative to horizontal) proximal of the saddle 34 has increased as the beam spring 22 has deflected so that the string 30 is a lever arm distance a1 from the cantilever mount 24. In this arrangement the relationship between string tension T1 and the torque/moment M1 can be estimated by M1=T1*α1. When the spring beam 22 is deflected as shown, the string mount 32 is vertically lower than the saddle 34. Due to the forces involved, the string 30 is pushed down onto the saddle 34 and nut 36, holding the string 30 in place and isolating vibrations on either side of the saddle 34 and nut 36. Thus, a playing zone 40 of the string 30 is defined between the saddle 34 and nut 36. The string 30 in the playing zone 40 is held at tension T1 and, when vibrating, emits the note corresponding to tension T1.

FIG. 3 depicts the arrangement of FIG. 2 after a change in environmental temperature (or other factor) has caused the string 30 to contract, decreasing the length of the string 30. The spring beam 22 thus is pulled by the string 30 so as to be further deflected d2. The reactive moment M2 also increases and the angle α2 of the string 30 relative to horizontal proximal of the saddle 34 is increased relative to α1, thus also increasing the lever arm distance a2. In this arrangement, then, d2>d1, M2>M1 and a2>a1. Also, the relationship between string tension T2 and the torque/moment M2 can be estimated by M2=T2*a2.

Although M2>M1, since a2>a1, the change in tension between T1 and T2 can be relatively small, even negligible. In a preferred embodiment, over an operational range of effective string length (and corresponding deflection of the spring beam 22), the tension T in the string 30 remains about the same in the arrangements depicted in FIGS. 2 and 3. In one example, the arrangement depicted in FIG. 3 provides tension T2 corresponding to the desired musical note emitted from string 30 when vibrating. Over time the string 30 stretches and spring beam deflection decreases from d2 (as in FIG. 3) to d1 (as depicted in FIG. 2) so that the tensioner arrangement is as depicted in FIG. 2. Even though M1<M2, preferably the relationship between a2 and a1 is such that T1 is substantially the same as T2, and the tension in the musical string 30 remains about the same so that any change in the note emitted by the vibrating string 30 in the arrangement shown in FIG. 2 versus the arrangement shown in FIG. 3 is not aurally detectable by human cars. As discussed in the embodiments that are incorporated by reference, the operational range can be a change in length in the string 30 of about 1 mm or, in other embodiments up to about 2 mm, and the acceptable change in tension/string note can be about 10 cents, 5 cents, 2 cents or less.

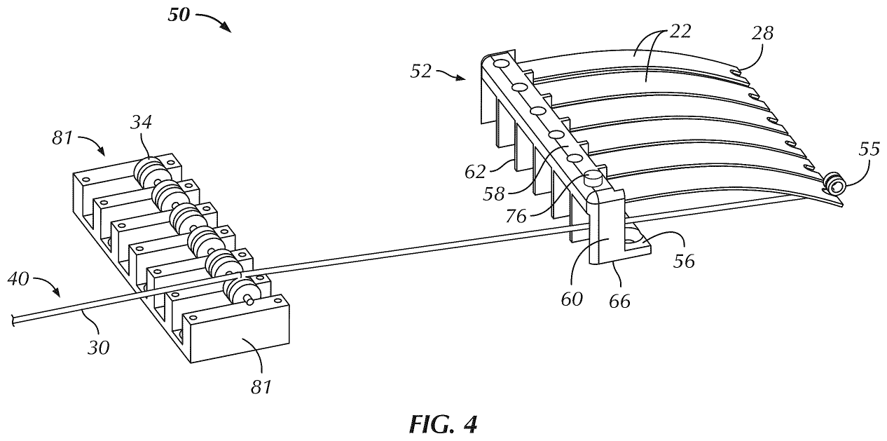

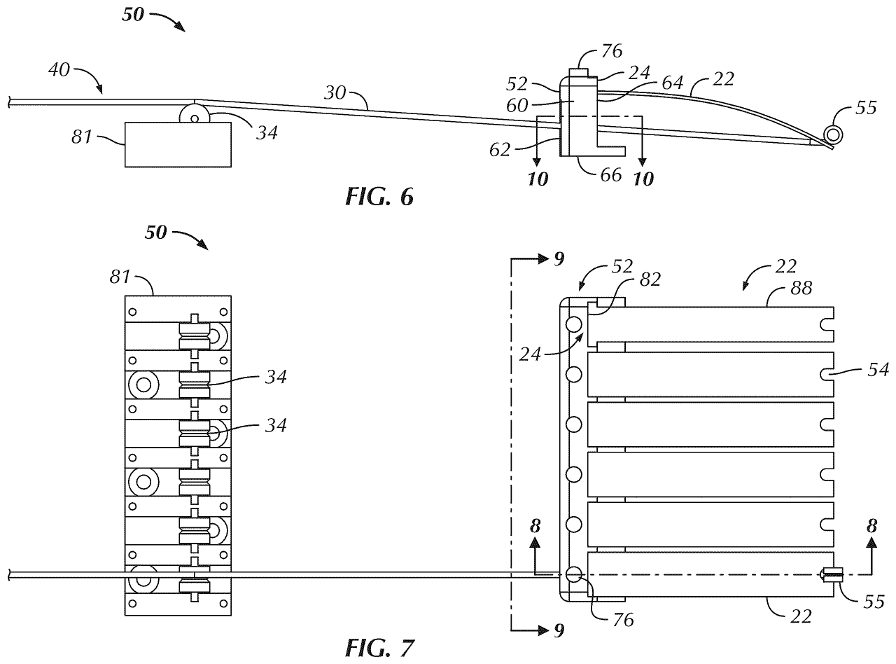

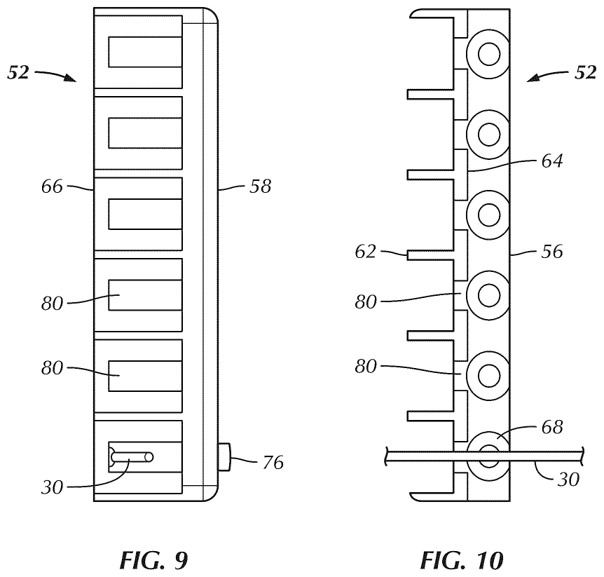

With reference next to FIGS. 4-10, an embodiment of a tensioner assembly 50 employs principles as discussed above schematically in connection with FIGS. 1-3. The illustrated tensioner assembly 50 is configured to be placed upon the body of a guitar, and is configured specifically for a 6-string guitar. The tensioner assembly 50 comprises a tensioner body 52 configured to hold six spring beams 22. Each spring beam 22 has a spring mount 32 that comprises a receiver slot 54 formed at the unsupported end 28 of the spring beam 22. The receiver slot 54 is sized and shaped to accommodate the string 30 extending therethrough and placed so that a string ball 55 is on the proximal side of the receiver slot 54. As such, when tension is applied to the string 30 in a distal direction, the string ball 55 engages the spring beam 22 at the string mount 32, pulling the unsupported end 28 distally and bending and deflecting the spring beam 22 so that the unsupported end 28 moves distally and downwardly. Preferably the musical string 30 is aligned with a longitudinal axis of the spring beam 22 and remains so aligned during bending so that the bending of the spring beam 22 is predictable and controlled.

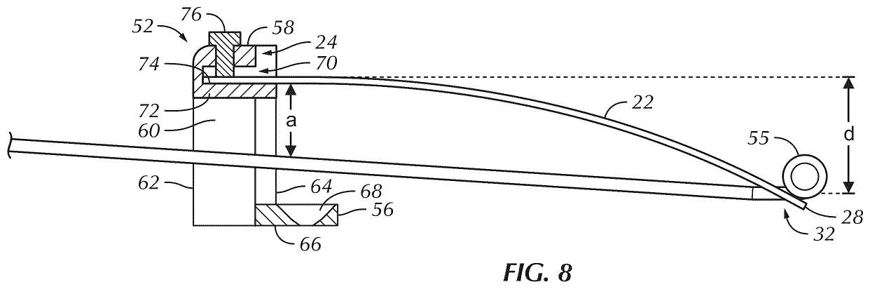

As best shown in FIG. 8, the tensioner body 52 comprises a base 56 and a top wall 58, with a vertical portion 60 extending therebetween. The vertical portion 60 also extends from a distal edge 62 to a proximal edge 64. A base surface 66 preferably is flat and configured to rest on the body of an instrument such as a guitar. Fastener receivers 68 can be formed through the base 56 and configured to receive fasteners that will attach the tensioner body 52 to the instrument.

A beam receiver 70 is formed between the top wall 58 and a support wall 72. The support wall 72 has a flat beam support surface 74 configured to receive a spring beam 22 resting thereon. The illustrated beam receiver 70 is open toward the proximal side so that the spring beam 22 can be advanced distally into the beam receiver 70, and extend proximally from the beam receiver 70. A distal end of the beam receiver 70 preferably is closed. A beam fastener 76 extending through the top wall 58 can be advanced to engage the spring beam 22 and hold it securely in contact with the beam support surface 74. In this manner, the beam receiver 70 and beam fastener 76 function as the cantilever mount 24 for the associated spring beam 22.

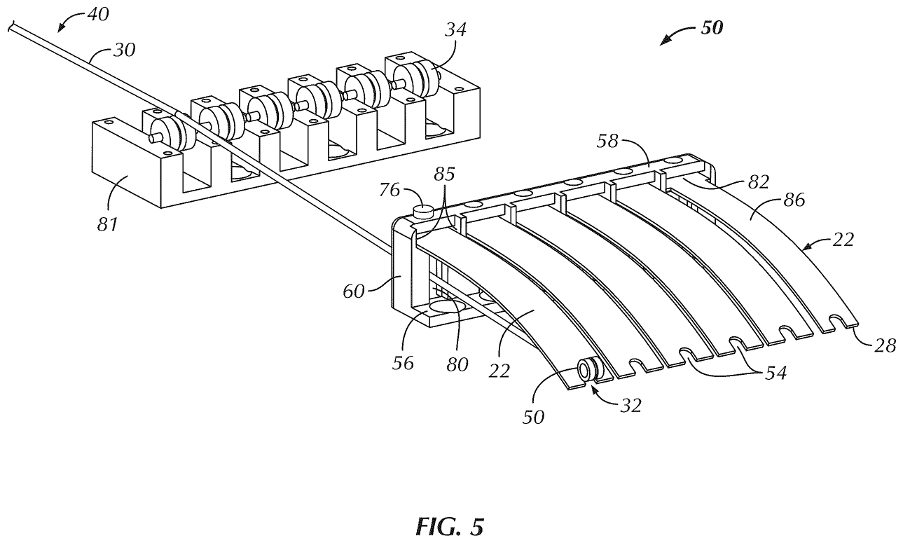

With particular reference next to FIGS. 5, 9 and 10, the vertical portion 60 of the tensioner body 52 supports the cantilever mount 24 so that it is spaced from the corresponding instrument body. The vertical portion 60 of the tensioner body 52 also includes string path cavities 80 that are positioned to be generally longitudinally aligned with the string mount 32 of the corresponding spring beam 22. As such, each string path cavity 80 is configured to receive a musical string 30 extending therethrough. Preferably, each string path cavity 80 is elongated sufficient in a vertical direction to enable the string 30 to move through a range of vertical positions without contacting the tensioner body 52.

With reference again to FIGS. 4-7, a bridge 81 is configured to be attached to the instrument body and distally spaced relative to the tensioner body 52. The illustrated bridge 81 includes a saddle 34 corresponding to each musical string 30. The illustrated saddles 34 are configured to roll over the bridge 81 in order to minimize friction as the string moves. It is to be understood, however, that any type or configuration of saddle 34 and bridge 81 can be provided, whether moveable (as shown) or not. Preferably, the saddle 34 is configured so that when the string 30 is under tension in its operational range, the saddle 34 is vertically higher than the string mount 32. In the illustrated embodiment the saddle 34 is vertically lower than the cantilever mount 24 and the string mount 32 when the string 30 is loose (see FIG. 1), and the spring beam 22 is in its straight, at-rest position. However, it is to be understood that, in additional embodiments, the saddle 34 can be vertically higher than the string mount 32 even when the spring beam 22 is not yet flexed.

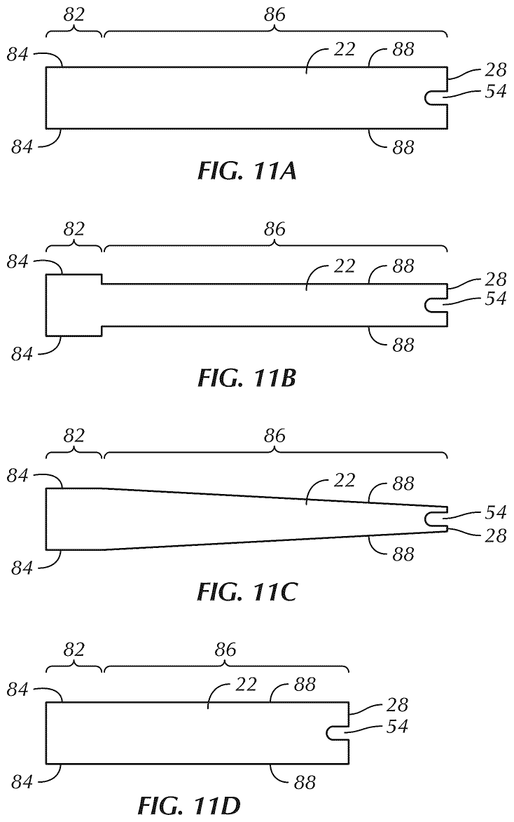

The beam receivers 70 preferably are configured to hold the corresponding spring beams 22 so that the spring beams 22 extend proximally in a direction parallel to the longitudinal axis of the instrument when at rest. The proximally-extending spring beams 22 and their corresponding distally-extending strings 30 most preferably are substantially aligned when at rest in a vertical planar axis. As such, tension exerted on the spring beam 22 by the string 30 is directed along the planar axis without tending to twist the spring beam 22. To this end, and with further reference to FIGS. 11A and 5, each spring beam 22 in the illustrated embodiment has a base part 82 with opposing, parallel side edges 84 and a standard width between the opposing side edges 84. Each beam receiver 70 is defined by opposing alignment walls 85 spaced apart by nearly the same width so that the base part 82 fits complementarily between the alignment walls 85 with the side edges 84 engaged with the alignment walls 85, and little to no play therebetween. This arrangement aligns the spring beam 22 properly so as to prevent or minimize out-of-axis twisting when string tension is applied. It is to be understood that additional or other structure can be employed, both on the spring beams 22 and the beam receivers 70, so as to attain and maintain proper alignment of the spring beams 22. For example, one or more notches can be formed in the base part 82 of the spring beam 22, and corresponding, complementarily-shaped protrusions formed in the beam receiver 70 can fit within the notches so as to hold the spring beam 22 in a manner that resists out-of-plane twisting when subjected to string tension. The beam support surface 74 of the tensioner body 52 and the base part 82 of the spring beam 22 preferably are sized and configured so that the beam support surface 74 corresponds to the size of the base part 82. For example, when in place, the base part 82 terminates at or near the proximal edge 64 of the beam support surface 74.

With continued reference to FIG. 11A, the illustrated spring beams 22 are elongated pieces made from a material having advantageous and predictable flexure properties, such as flat spring steel. Such flat spring steel is flat and straight when in an at-rest, untensioned position. A flexure part 86 of the spring beam 22 extends from the base part 82 to the unsupported end 28. The flexure part 86 includes opposing side edges 88 that extend from the base part 82 to the unsupported end 28. In the spring beam 22 illustrated in FIG. 11A, the opposing side edges 88 are parallel and contiguous with the base part side edges 84. As such, the entire spring beam 22 is substantially rectangular. With additional reference to FIG. 11B, another embodiment of a spring beam 22 has parallel opposing side edges 88 in the flexure part 86, but the width between the side edges 88 is less than the width between the base part side edges 84. As such, even if the spring beam of FIG. 11B has the same thickness and material as that of FIG. 11A it will exhibit different flexure properties. In other variations a spring beam 22 may be wider in the flexure part 86 than in the base part 82.

It is to be understood that additional spring beam configurations can be employed in order to tailor flexure properties to obtain desired performance. For example, the spring beam 22 depicted in FIG. 11C has flexure part side edges 88 that taper moving toward the unsupported end 28. The spring beam 22 depicted in FIG. 11D is rectangular, similar to that in FIG. 11A, but has a shorter length in the flexure part 86, and thus can be expected to exhibit different flexure properties. In further variations, different spring beams 22 can have different thicknesses or be made of different materials having different bending properties. For example, in some embodiments spring beams can be made of different metals, plastics, and fiber reenforced composites.

Stringed musical instruments typically involve multiple strings, each having a different tension so as to emit a wide range of notes. Thus, in order to provide appropriate tension range properties, a spring beam 22 is selected for each string 30 so that the corresponding spring beam 22 works well in the particular range of desired string tension for that string 30. For example, with reference again to FIG. 5, one of the spring beams 22 being secured in the tensioner assembly 50 is configured like the spring beam 22 of FIG. 11B in order to best provide flexure and tension properties appropriate for the corresponding musical string 30. It is contemplated that a musical instrument employing multiple strings 30 can use a differently-configured spring beam 22 for one, more, or all of the strings 30.

It is to be understood that spring beams 22 having different configurations, such as differing geometric configurations as in the illustrated embodiments, but also having differences such as thickness and material, can be employed. Also, in the illustrated embodiments the tensioner body 52 is configured to define cantilever mounts 24 that hold each spring beam 22 so as to be substantially horizontal when in an untensioned, at-rest position. In additional embodiments one or more of the cantilever mounts 24 can be configured so that the associated spring beam 22 extends generally upwardly a range of angular degrees relative to horizontal when in the at-rest position, and in still additional embodiments one or more cantilever mounts 24 can be configured so that the spring beam 22 extends generally downwardly a range of angular degrees when in the at-rest position. And further, owing to the differences in tension and performance requirements from string to string, each cantilever mount 24 can be configured to have different at-rest orientations of associated spring beams 22 for each of the corresponding string positions.

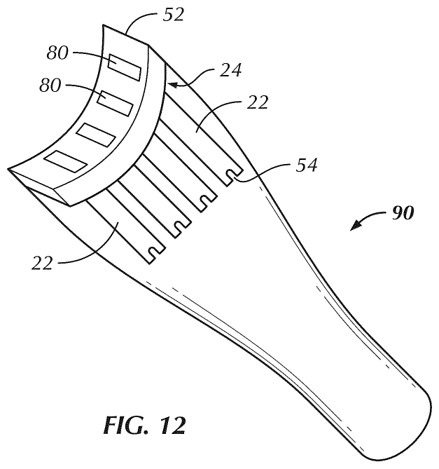

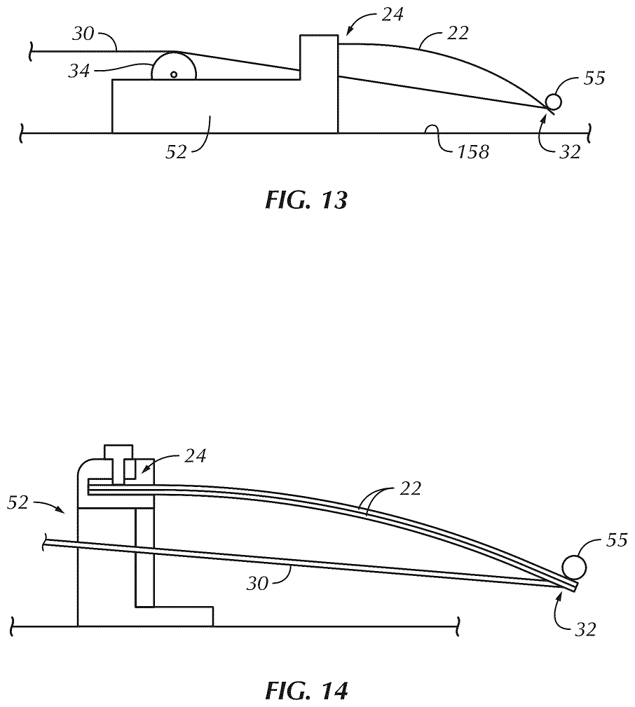

The embodiments discussed above in connection with FIGS. 4-10 have depicted a tensioner body 52 and bridge 81 configured to be attached to the body of a 6-string guitar. It is to be understood, however, that various versions and configurations employing principles as discussed herein can be provided. As an example, and with reference next to FIG. 12, an embodiment of a violin tailpiece 90 is depicted in which a tensioner body 52 is unitarily incorporated as part of the tailpiece 90. As is typical with violins, the tailpiece is arcuate about its longitudinal axis. As such, each cantilever mount 24 of the tensioner body 52 holds its corresponding spring beam 22 so as to lie in a different plane. But as above, the spring beams 22 are each directed in a proximal direction from the associated cantilever mounts 24. Strings 30 can engage the corresponding string mounts 32 and be drawn distally, through string paths 80 and over a typical violin bridge, across the neck and nut to typical tuning pegs. In some variations, the saddle portions of the violin bridge can be coated with Teflon® or another low-friction surface treatment so as to reduce resistance to the string moving longitudinally over the saddle. The tailpiece 90 can be attached to the corresponding violin in the same manner as with typical violins and tailpieces. In the illustrated embodiment the tailpiece 90 is unitarily formed, including the tensioner body 52.

With additional reference next to FIG. 13, another embodiment is depicted in which the support body 52 includes both the cantilever mounts 24 and the saddles 34 combined using a common base 56. The support body 52 is configured to be mounted directly to the body of the associated musical instrument. It is to be understood that other variations can include other specific structures, and other configurations can employ principles as discussed herein. For example, in another embodiment, cantilever mounts supporting spring beams can be disposed in a neck of the musical instrument, while pegs for tightening the strings can be arranged on or adjacent the body of the instrument.

It is anticipated that a particular spring beam 22 can be selected so that, within its operating range of deflection, it holds the associated string 30 at the correct, desired tension. It is to be understood that additional embodiments and variations can allow particular arrangements to be tuned so that even if a particular spring beam 22 isn't quite configured to operate at the desired tension (due to, for example, manufacturing variability and/or availability of spring beams having particular properties), additional tuning mechanisms can be provided. Thus, additional embodiments are contemplated that allow modification of the cantilever mount 24 and/or spring beam 22 so as to allow fine tuning.

With reference next to FIG. 14, in one embodiment, if, for example, a particular spring beam 22 does not provide a high enough tension in the operating range, a second spring beam 22 can be added and disposed atop the first spring beam 22. The second spring beam 22 can be identical to the first or, in other variations, can differ in structural and/or performance criteria due to geometrical and/or material differences.

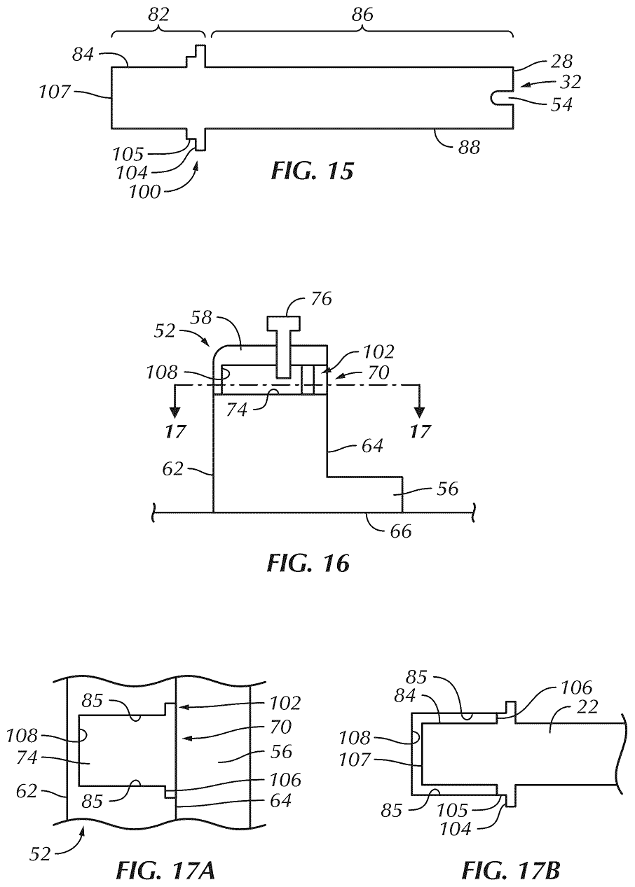

Referring next to FIG. 15, another embodiment of a spring beam 22 comprises an alignment structure 100 located at and adjacent the proximal end of the base part 82 of the spring beam 22. In the illustrated embodiment, the alignment structure 100 extends radially outwardly from the side edges 84 on opposing sides of the spring beam 22. With additional reference to FIGS. 16 and 17A-B, the beam receiver 70 of the tension body 52 includes an alignment portion 102 that is configured to receive the alignment structure 100 of the beam 22.

Continuing with reference to FIGS. 15-17A-B, each alignment structure 100 further includes a force surface 104 that is open toward the distal direction, and an alignment surface 105. In the illustrated embodiment the alignment surfaces 105 are arranged so as to be complementary to the opposing alignment walls 85 of the beam receiver 70. The alignment portion 102 includes force walls 106 that are open toward the proximal direction. As the base part 82 of the spring beam 22 is advanced into the beam receiver 70 (see FIG. 17B), the alignment surfaces 105 of the spring beam 22 register with the alignment walls 85 of the receiver 70, and the force surfaces 104 of the spring beam 22 engage the force walls 106 of the tension body beam receiver 70. Since the alignment surfaces 105 are registered with the alignment walls 85, the spring beam 22 is kept in proper alignment even if the side edges 84 of the base part 82 do not register with the walls 85 of the beam receiver 70. Since the force surfaces 104 engage the force walls 106, a distally-directed force applied to the spring beam 22 is applied to and countered by the tension body 52 via the engaged force surfaces 104 and force walls 106. When a string 30 is attached to the spring beam 22 and tightened, tension in the string 30 applies a distally-directed force to the spring beam 22, which force is countered by the spring beam's contact with the tension body 52. In this embodiment, the distally-directed force on the spring beam 22 is communicated via the force surfaces 104 to the tension body 52 via engagement with the force walls 106. In the illustrated embodiment, the beam receiver 70 is configured so that a distal end 107 of the spring beam 22 is spaced from a proximal wall 108 of the beam receiver 70 (see FIGS. 17B & 18A) so that there is no axial force-communicating contact between the distal end 107 and the proximal wall 108. Thus, in this embodiment, the tension body 52 provides axial-force support of the spring beam 22 at or adjacent the proximal end of the base part 82, which is at or adjacent the proximal edge 64 of the tension body 52 at the beam receiver 70.

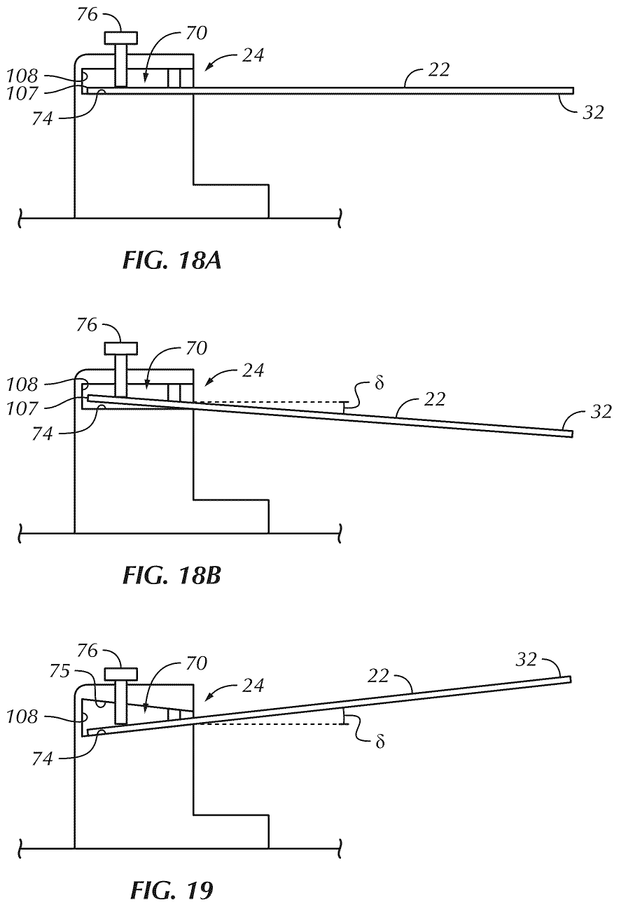

With specific reference to FIG. 18A, an embodiment is shown in which a spring beam 22 as in FIG. 15 is held within a beam receiver 70 so that the alignment structure 100 of the spring beam 22 is registered with the alignment portion 102 of the beam receiver 70, the spring beam 22 is resting on the horizontal support surface 74, and beam fastener 76 is engaged with the base part 82 so as to hold the spring beam 22 securely with the spring beam 22 extending proximally outwardly in a horizontal orientation when at rest.

As in embodiments discussed above, when a string 30 is attached to the spring beam 22 and tension is applied to the string 30, the spring beam 22 will deflect. Over an operating range of deflection of the spring beam 22 the tension T in the string 30 will stay relatively constant.

However, in some configurations the spring beam 22 may be slightly too stiff, and the tension T while in the operating range of deflection may be too high. With reference next to FIG. 18B, the string holder system can be tuned by loosening the beam fastener 76 somewhat so that the spring beam 22 is inclined downwardly while at rest. More specifically, the spring beam 22 is inclined downwardly an angle δ relative to horizontal. In this configuration, application of less string tension T will reach the operational range of beam deflection. Thus, changing the at-rest, initial angle δ of the spring beam 22 relative to the cantilever mount 24 can, effectively, tune the string holder.

With reference next to FIG. 19, another embodiment is illustrated in which the support surface 74 within the beam receiver 70 is angled so as to allow the spring beam 22 to be disposed at an angle δ above horizontal in its initial, at-rest position. Such an arrangement will allow tuning when a greater tension need be applied when the spring beam 22 is in the operational range of deflection. Also, in this embodiment, an upper surface 75 in the beam receiver 70 is also angled. Thus, in this embodiment, adjustment of the beam fastener 76 allows tuning/adjustment of the spring beam 22 through a range of below-horizontal angles and above-horizontal angles. In this context, horizontal refers to a plane generally parallel to an adjacent surface—or deck—of the corresponding instrument. It is to be understood that the present structure can provide for a range of angles relative to other structure as is relevant to the particular application.

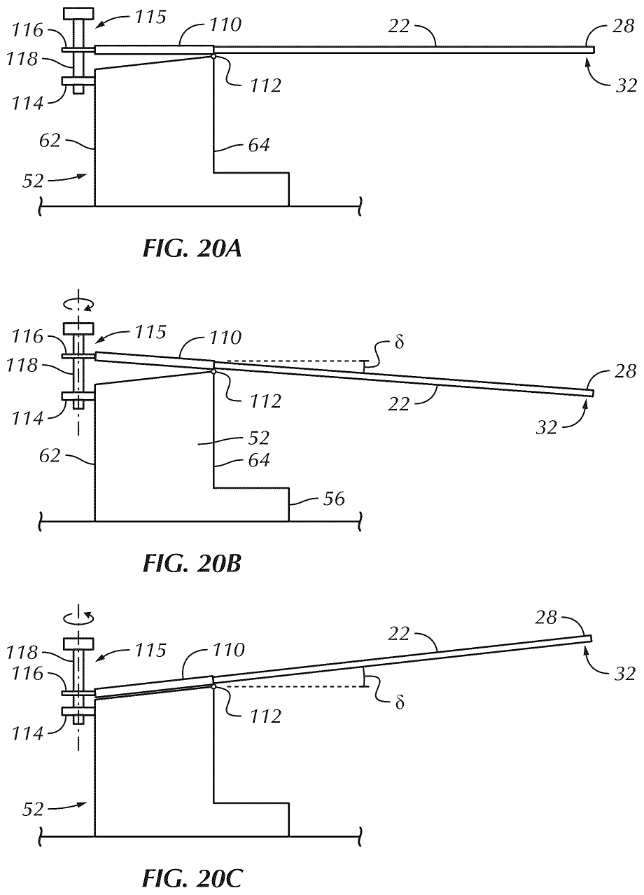

With reference next to FIGS. 20A-20C, another embodiment of a tension body 52 includes a beam holder 110 that is configured to accept and retain the base part 82 of a spring beam 22 in any manner. A proximal end of the beam holder 110 is attached to the tension body 52 at a pivot 112 so that, by rotating the beam holder 110 about the pivot 112, the corresponding at-rest angle δ of the spring beam 22 can be varied along a range both above and below horizontal as desired. An adjustment mechanism 115 can be provided to move the beam holder 110 to a desired angle and then hold it securely at the angle. In the illustrated embodiment, the adjustment mechanism comprises a threaded screw 118 that extends through a base mount 114 on the tension body 52 and a threaded pivot mount 116 on the beam holder 110. Rotation of the screw 118 moves the distal end of the beam holder 110 up or down relative to the tension body 52, and thus adjusts the angle δ of the beam holder 110.

To effect tuning, the user may elect to start from a neutral orientation, such as with the spring beam 22 horizontal as shown in FIG. 20A. A string 30 can then be applied at the string mount 34 and brought to tension within the operational range of deflection of the spring beam 22. If the tension in the string 30 is too high, the user may actuate the screw 118 to pivot the beam holder 110 downwardly (see FIG. 20B), thus decreasing the tension until the desired tension is reached. Similarly, if the tension in the string 30 is too low, the user may actuate the screw to pivot the beam holder 110 upwardly (see FIG. 20C), thus increasing the tension until the desired tension in the string 30 is reached.

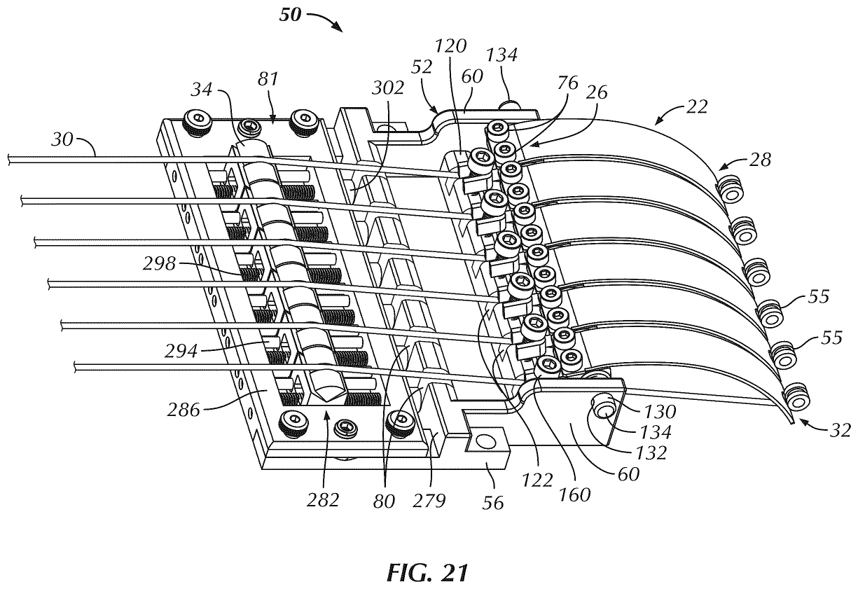

With reference next to FIGS. 21-26, another embodiment of a tensioner assembly 50 comprises a base 56 having a base surface 66 that is configured to lie upon and a boy of a stringed instrument. The base 56 is configured to support a bridge assembly 81 at a distal portion and has a tensioner body 52 at a proximal portion. The tensioner body 52 includes spaced-apart vertical portions 60. A cross member 120 extends between the vertical portions 60, preferably along the base surface 66. An elongated rod 130 is supported by and extends between the vertical portions 60 proximal of and vertically higher than the cross member 120. A pair of rod apertures 132 are formed in the vertical portions 60 can are configured to receive the rod 130 so that opposing rod ends 134 extend outwardly from the vertical portions 60. In the illustrated embodiment the rod 130 is elongated and cylindrical along its length. In some embodiments the rod 130 is mounted in a manner so that it is static. In additional embodiments the rod 130 can be mounted in a manner so that it is rotatable.

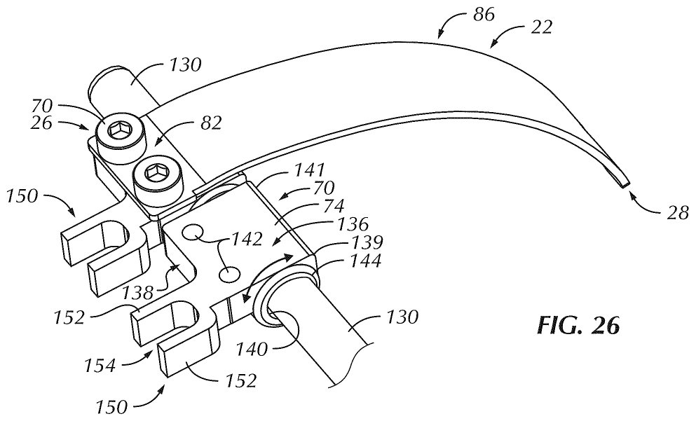

A plurality of beam receivers 70 are supported by the rod 130. Each beam receiver 70 is configured to hold a spring beam 22. In the illustrated embodiment the musical instrument includes six musical strings 30, and thus six beam receivers 70 are supported on the rod 130. As best shown in FIG. 26, each beam receiver 70 comprises a receiver body 136 having a distal end 138 and a proximal end 139. A bore 140 extends through the body 136. The bore 140 preferably is substantially cylindrical and has a diameter slightly greater than a diameter of the rod 130 so that the rod 130 will fit through the bore 140 and the beam receiver 70 can rotate about the rod 130. Preferably, each of the plurality of beam receivers 70 can rotate independently about the rod 130. A spacer 144 is disposed on each of opposing sides of the receiver body 136. The spacers 144 are sized and configured to maintain a desired spacing between the beam receivers 70 so that adjacent musical strings 30 are supported the appropriate distance from one another. For example, in six-string guitars the strings often are spaced about 0.41 in. from one another, and it is preferred that the width of the spring beams 22 in such applications are about 0.354 in. or less in order to provide for some room between adjacent beams.

Continuing with particular reference to FIG. 26, a beam support surface 74 is provided on the beam receiver body 136. The beam support surface 74 is configured to receive the base part 82 of a spring beam 22 in a manner so that the base part 82 is generally aligned with the distal end 139 and the flexure part 86 of the spring beam 22 extends distally beyond the proximal end 138. A pair of threaded support bosses 142 are formed in the receiver body 136 and are configured to receive a pair of fasteners 76 that also extend through apertures in the base part 82 of each spring beam 22. Other structures, such as a clamp or the like, can also be used to hold the spring beam 22 onto the receiver body 136. A tuner receiver 150 extends distally from the receiver body 136 and comprises a pair of opposing spaced apart arms 152 that define a tuner cavity 154 therebetween.

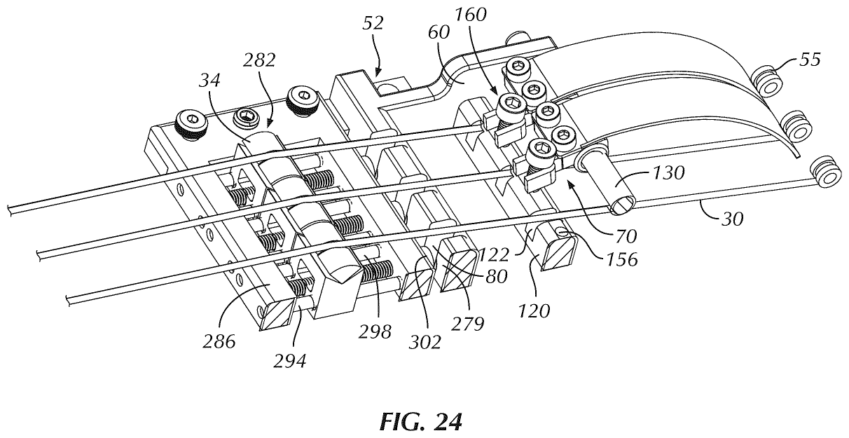

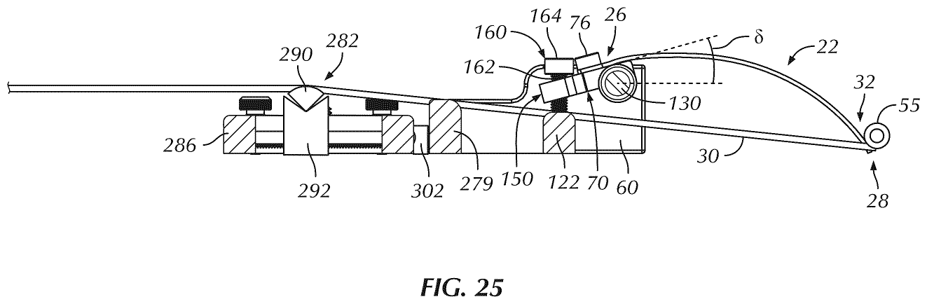

With particular reference next to FIGS. 24 and 25, a plurality of spaced-apart threaded tuner bosses 156 are formed through a top surface of the cross member 120. The tuner bosses 156 are spaced and arranged to align with corresponding ones of the tuner receivers 150. A tuner 160 is provided for each tuner receiver 150 and tuner boss 156. Each tuner 160 is a fastener comprising a threaded shaft 162 and a head 164. As shown, the shaft 162 extends through the tuner cavity 154 and threadingly engages the corresponding tuner boss 156. In this manner, the tuner head 164 engages top surfaces of the arms 152 of the tuner receiver 150. As such, the tuner 160 limits the range of rotation of the beam receiver 70 about the rod 130, and this range of rotation can be adjusted by threading the tuner 160 further into or out of the associated tuner boss 156.

Continuing with reference to FIGS. 21-26, in practice, a musical string 30 is aligned with each of the spring beams 22 so that the string ball 55 is received in the receiver slot 54 at the unsupported end 28 of the spring beam 22. The musical string 30 is drawn distally between the beam receiver 70 and cross member 120, onto the saddle 34 and nut 36 and attached to a tuning peg 38. Slots 122 can be formed in the cross member 120 to accommodate the musical string 30. As shown, the tuner bosses 156 are offset from the slots 122 so as to not interfere with the musical string 30. As such, and as shown, the tuner receiver 150 of each beam receiver 70 is correspondingly offset relative to a longitudinal axis of the beam receiver 70. The strings 30 will tend to be aligned with the longitudinal axis of the beam receiver 70.

As the musical string 30 is tightened, the tension applied by the musical string 30 imposes a moment on the spring beam 22 tending to rotate the beam receiver 70 clockwise in the view depicted in FIGS. 24-26. Rotation of the beam receiver 70 beyond a selected range is blocked by the tuner 160 engaging the tuner receiver 150, and upon continued application of tension the spring beam 22 bends as depicted in the drawings. The degree to which the tuner 160 is advanced into the associated tuner boss 156 determines an angle δ of the beam support surface 74 relative to an associated instrument body surface or deck 158, which is depicted as horizontal in the drawings. This thus determines an initial, or at-rest, angle δ of the spring beam 22, which angle δ can be readily varied along a range both above and below horizontal as desired. The proximal end 139 of the receiver body 136 includes a rounded edge 141 to accommodate bending of the spring beam 22 and avoid stress concentrations. In additional embodiments, the proximal end 139 can have a rounded configuration generally following the curvature of the bore 140.

In order to install and tune a musical string 30, a first step can be to select an appropriate spring beam 22. Selection of an appropriate spring beam 22 can depend on the corresponding musical string 30. As discussed above, spring beams can be provided with different widths, configurations, lengths, thicknesses, material composition, and the like. As such, a first spring beam 22 may be configured so that, when tension is applied, it provides a tension appropriate for, for example, a violin's D string, while a second spring beam 22 may be configured to provide correct tension for a guitar's A string. In some embodiments, a set of spring beams 22 can be provided in which each spring beam 22 is configured to be used with a corresponding string of the particular musical instrument.

Once the correct spring beam 22 is selected, the spring beam 22 can be mounted onto the corresponding beam receiver 70 via the fasteners 76. The string 30 can then be mounted, such as by placing the ball 55 proximal the receiver slot 54, drawing the string 30 through the slot 54 and distally between the beam receiver 70 and cross member 120 and over and onto the saddle 34 and nut 36 and to the tuning peg 38. The string 30 can then be tightened with the tuning peg 38 until the beam 22 is deflected and the tension in the string 30 approaches the desired tension. This practice is anticipated to provide a rough tune of the string, in which the tension in the string is close to the desired perfect-tune tension. The user can then engage the corresponding tuner 160 threadingly advancing the tuner 160 in order to tighten the string or threadingly retracting the tuner 160 in order to decrease tension until a perfect-tune tension is reached.

Once the musical string 30 is set at the desired perfect tune tension, variations in string lengths that can be expected during use and due to passage of time, environmental factors or the like, will result in a change in both the bend of the spring beam 22 and a corresponding change in lever arm so that, as discussed above, the tension in the musical string 30 will remain substantial unchanged over a desired range of operation, resulting in substantially no aurally detectable difference in emitted sound frequency.

It is anticipated that in some applications, such as with a guitar, the user may be wish to “bend” notes, which involves stretching the string 30 within the playing zone 40 in order to change string tension and thus vary the note emitted by the vibrating string. During bending of notes it is desired that the tensioner assembly 50 not operate to compensate for string stretching. In some embodiments, in order to set up the guitar for bending notes, the strings will be installed while manipulating both rough tuning and fine tuning so that the string mounts 32 are close to and adjacent the deck 158 of the instrument. Thus, when the user intentionally deflects the string 30 during bending, further bending of the beam spring 22 is stopped by the unsupported end 28 engaging the instrument deck 158. The tensioner assembly 50 is thus prevented from preventing change in tension, and the bend successfully changes the note emitted by the string 30 during bending.

In some embodiments a stop pad 170 can be applied to the instrument deck 158 at the location in which the unsupported end 28 will engage the instrument body during bending. The stop pad 170 can protect the instrument from scratching or other damage. Also, the stop pad 170 can comprise a material having properties configured to prevent the spring beam 22 from damaging the instrument body and in some environments can have elastomeric properties preventing potential for buzzing. In another embodiment an elastomeric material can be attached to the unsupported end 28 of the spring beam 22.

In embodiments in which there is no desire for note bending, installation of the strings 30 can manipulate the rough tuning and fine tuning steps so that at the perfect tune tension the unsupported end 28 of the spring beam 22 remains sufficiently spaced from the instrument body so that the unsupported end 28 will not contact the instrument deck 158 during the operating range of string length variation.

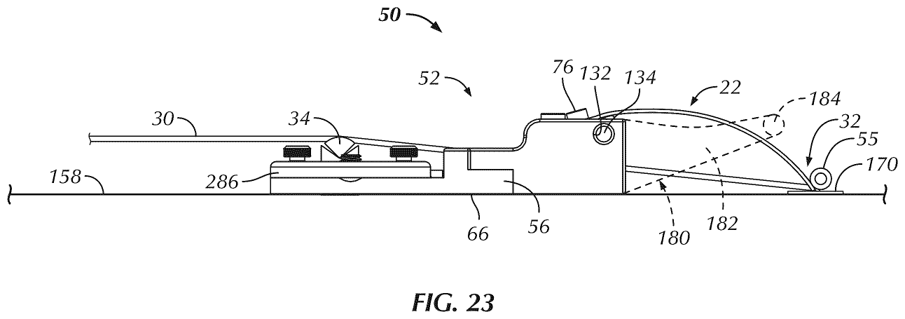

With reference particularly to FIG. 23, in an optional embodiment, a back stop structure 180 is provided as part of the tensioner body 52. As shown, the back stop structure can comprise spaced-apart backstop walls 182 that extend proximally and support a back stop bar 184 extending therebetween. As such, the spring beams 22 can be directed under the back stop bar 184. In this configuration, if the tightened musical string 30 were to break, the back stop bar 184 would block the spring beam 22 from snapping back to a fully-extended position. In some embodiments the back stop bar 184 is configured so that an operational range of the spring beam 22 is in a range of deflection between the back stop bar 184 and the stop pad 170.

The principles discussed above can be applied to different configurations, such as a violin tailpiece in which the strings are supported along an arcuate path. In such an embodiment, each string can have its own, independent tension body having its own rod and rotating beam receiver, all oriented in a manner to arrange the string as desired.

In the embodiments discussed in connection with FIGS. 21-26, the beam receiver 70, rod 130 and the like function as the cantilever mount 24 schematically represented in FIGS. 1-3. Notably, such embodiments demonstrate the principle of a cantilever mount that can be rotated for adjustment and tuning.

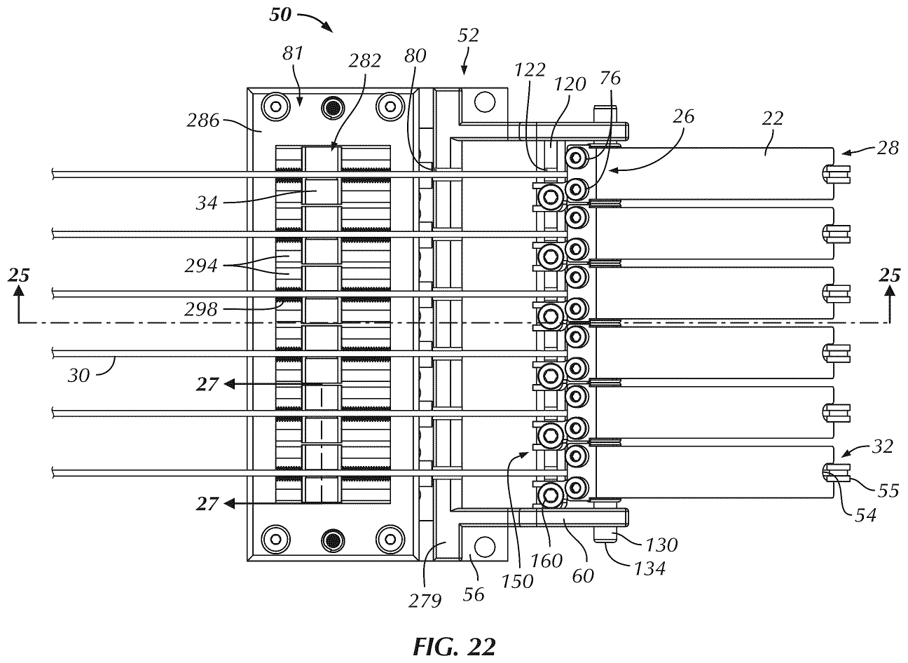

As noted above, the embodiment illustrated in FIGS. 21-22 includes a bridge assembly 81 supported at a distal portion of the base 56. The illustrated bridge assembly 81 comprises a frame 286 that can be attached to the base 56 via fasteners as shown. The bridge assembly 81 supports a plurality-here, six-of saddle assemblies 282, each of which is configured to support a musical string 30. In other embodiments, it can be anticipated that the bridge assembly 81 can be independent of the base 56 of the tension body 52. The illustrated base assembly 81 includes a support wall 279. String path cavities 80 are formed in the support wall 279 to provide paths for the strings 30. In some embodiments the support wall can be deleted.

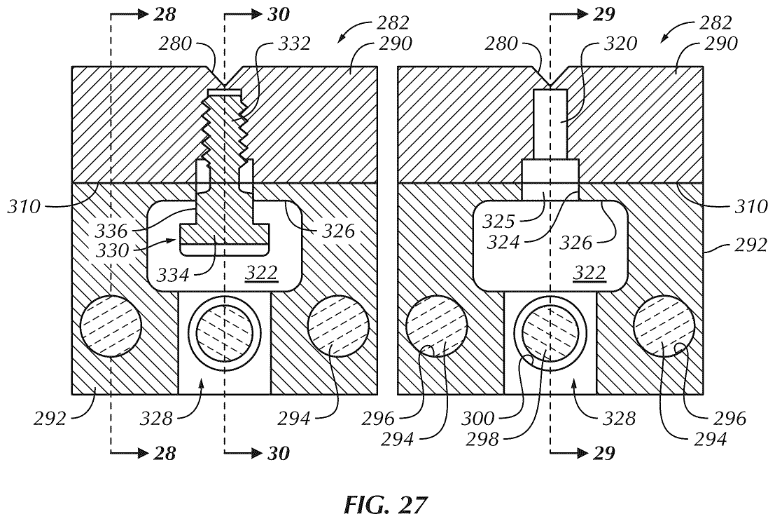

With additional reference to FIGS. 27-29, in the illustrated embodiment, each of the saddle assemblies 282 comprises a saddle body 290 supported by a base 292. Each saddle body 290 has an elongated string receiver 280 configured to accommodate a musical string 30. Each base 292 is configured to slide over a pair of alignment rods 294, which extend through rod receivers 296 formed in the base. The alignment rods 294 are supported by the frame 286. A threaded adjustment bolt 298 is received in a correspondingly threaded bolt receiver 300 formed in the base. The adjustment bolt 298 is rotatably supported by the frame 286 so that when a head 302 of the adjustment bolt 298 is rotated, the position of the base 292 can be changed so as to, for example, adjust intonation of a corresponding guitar string 30.

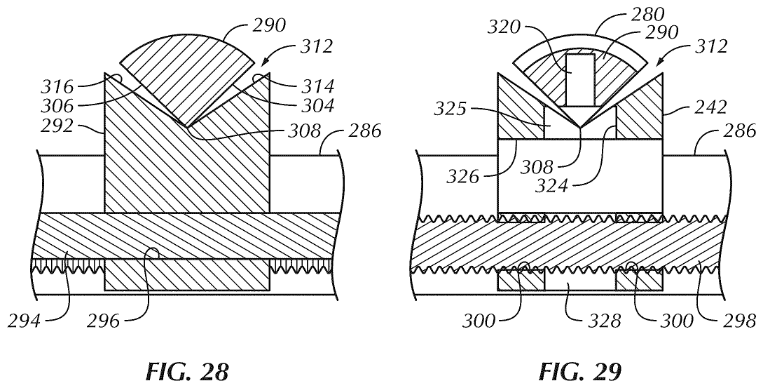

With particular reference to FIG. 28, each saddle assembly base 292 pivotably supports the corresponding saddle body 290. More specifically, when the musical string 30 is in place and suitably tightened, force exerted by the string 30 will urge the saddle body 290 into engagement with the base 292. First and second body surfaces 304, 306 extend from opposing ends of the string receiver 280 and taper to meet at a pivot tip 308. In the illustrated embodiment the pivot tip 308 comprises an elongated and straight pivot edge 310 extending in a direction generally normal to an axis of the string receiver 280. The first and second body surfaces 304, 306 preferably meet each other at a tip angle of less than 90°, and more preferably between about 50-85°, and even more preferably between about 75-80°.

A body receiver 312 is formed within the saddle assembly base 292 and is configured to receive the saddle body 290 so that the saddle body 290 can pivot within the body receiver 312. The body receiver 312 comprises a first surface 314 and a second surface 316 that intersect one another to form a V-shape, with the V having an angle greater than the tip angle of the saddle body 209. Most preferably, the V angle is 10-40° greater than the tip angle. As such, the saddle body pivot tip 308 is received and supported by the V, and the saddle body 290 can pivot relative to the base 292 substantially without friction over a range of pivot angles. In this manner, the saddle body 290 will pivot as the corresponding musical string 30 stretches and contracts, and the string 30 is not expected to slide over the surface of the string receiver 280 during such pivoting.

With specific reference next to FIGS. 27 and 29, each saddle body 290 has a sufficient width so as to provide appropriate spacing between strings and also to provide stability during pivoting. The pivot edge 310 of each saddle body 290 extends across the width of the saddle body 290, except that a retainer receiver 320 can be formed in each saddle body 290. In the illustrated embodiment, the retainer receiver 320 is a cavity extending through the pivot edge 310 and generally aligned with the string receiver 280. The base 292 has a base space 322 defined therein. A base aperture 324 is formed through the first and second surfaces 314, 316 of the base 292 and defines the cross-section of a base passage 325 that is aligned with the retainer receiver 320 of the saddle body 290 so that the base space 322 communicates with the retainer receiver 320. A blocking surface 326 of the base space 322 is defined at and adjacent the base aperture 324. An access passage 328 is also formed through the base 292 opposite and aligned with the base passage 325.

The string receiver 280 can have a constant radius of curvature along its length, and the radius of curvature is taken about the pivot tip 308. As such, the saddle body 290 can pivot substantially without friction losses, and even though the saddle body 290 has pivoted, the string 30 releases from contact with the string receiver surface of the saddle body at substantially the same point relative to the saddle body base 292, which doesn't move. Thus, the playing length of the string 30, and thus intonation, remains the same during elongation or contraction of the string 30.

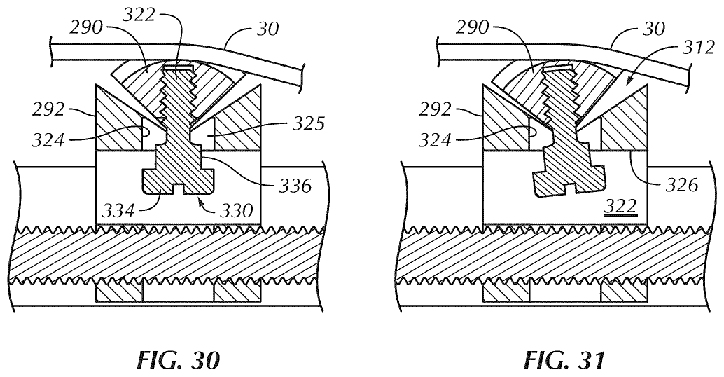

During assembly of the bridge 280 a retainer 330, which in this embodiment is a bolt, can be installed into the retainer receiver 320. The retainer 330 comprises an elongated threaded shaft portion 332 and a retainer head portion 334. A guide portion 336 can be disposed between the shaft 332 and the head 334, and can have a diameter less than that of the retainer head 334. The base aperture 324 can be about the same width as the guide portion diameter. The base portion width, however, is less than the diameter of the retainer head 334. As such, the retainer head 334 will not fit through the base aperture 324. The access passage 328 can have a width at least as great as the retainer head diameter so that the retainer member 330 can be advanced through the access passage 328 and advanced into place in the retainer receiver 320 as shown in FIGS. 27 and 30. As shown, when the retainer member 330 is fully advanced, the retainer head 334 remains spaced from the base aperture 324 and the blocking surface 326 of the base space 322 as shown.

With specific reference next to FIG. 30, a length of the base aperture 324 can be greater than the width of the base aperture 324 (as depicted in FIG. 27). As such, even when the saddle body 290 pivots, as depicted in FIG. 31, the retainer member 330 is spaced from any contact with the base 292 that would block or otherwise inhibit such pivoting. Thus, the retainer member 330 does not restrict or otherwise interfere with pivoting of the saddle body 290 when the pivot edge 310 is engaged with the base 292.

If a musical string 30 breaks or is otherwise removed from the saddle body 290, the force keeping the saddle body 290 pressed against the base 292 will no longer be present, and the saddle body 290 will be subject to falling off the base 292 due to gravity. However, if the saddle body 290 moves away from the base 292 a short distance, referred to as a clearance distance, the retainer head 334 will engage the blocking surface 326 of the base 292, and the retainer head 334 will not be able to fit through the base aperture 324. Thus, the saddle body 290—though loose—will be retained at and adjacent the base 292.

In the above embodiment the bridge assembly 81 is supported by the same base 56 that supports the tensioner body 52. It is to be understood that, in additional embodiments, the tensioner body 52 and bridge assembly 81 can be separately formed and even separately secured to the instrument body. Further, in some embodiments an instrument may employ a more traditional bridge structure that does not employ pivoting or rotating saddles. For example, in one embodiment a violin can use a tensioner body 52 as discussed above but still employ a traditional bridge over which the string 30 does not readily slide. As such, adjustments by the tensioner body 52 to substantially instantly adjust factors to maintain substantially constant string tension will instead occur relatively slowly. This will enable a violinist to still apply stylistic touches, such as vibrato, but the violin will still achieve and maintain perfect tune with continued play.

The embodiments discussed above have been disclosed in the context of replacing a traditional bridge of an instrument such as a guitar, and contemplate placement on the instrument in the same location as a traditional bridge placement. It is to be understood, however, that in other embodiments the tensioner body can be mounted on a headstock of a stringed instrument, and the tuning pegs can be oriented in the location at which the bridge is traditionally placed.

The embodiments discussed above have disclosed structures with substantial specificity. This has provided a context for disclosing and discussing inventive subject matter. However, it is to be understood that other embodiments may employ different specific structural shapes and interactions. For example, other types and configurations of spring beams (such as torsion springs, rotationally-mounted gas springs, etc.) can be employed, and the principles discussed herein can be developed for applications other than for musical instruments. For example, yet additional modes can be further developed for holding a spring beam and changing its mount angle in a manner that is controlled and secure can acceptably practice principles disclosed herein. Indeed, several different specific structures can employ aspects and principles discussed in this specification.

Although inventive subject matter has been disclosed in the context of certain preferred or illustrated embodiments and examples, it will be understood by those skilled in the art that the inventive subject matter extends beyond the specifically disclosed embodiments to other alternative embodiments and/or uses of the invention and obvious modifications and equivalents thereof. In addition, while a number of variations of the disclosed embodiments have been shown and described in detail, other modifications, which are within the scope of the inventive subject matter, will be readily apparent to those of skill in the art based upon this disclosure. It is also contemplated that various combinations or subcombinations of the specific features and aspects of the disclosed embodiments may be made and still fall within the scope of the inventive subject matter. Accordingly, it should be understood that various features and aspects of the disclosed embodiments can be combined with or substituted for one another in order to form varying modes of the disclosed inventive subject matter. Thus, it is intended that the scope of the inventive subject matter herein disclosed should not be limited by the particular disclosed embodiments described above.

What is claimed is:

1. A string tensioner for a stringed musical instrument, comprising:
a tensioner body extending from a base to a spring support;
an elongated spring member having a first end, a second end and a string mount, the string mount configured to accept a musical string mounted thereon; and
a spring receiver disposed in the spring support, the spring receiver configured to receive the first end of the spring member so that the spring member is held with a flexure portion of the spring member extending proximally from the spring receiver to the string mount;
wherein a distally-directed tension force exerted by the musical string on the string mount imposes bending on the spring member.

2. The string tensioner of claim 1, wherein the spring receiver is configured to be selectively rotatable relative to the tensioner body.

3. The string tensioner of claim 1, wherein at a first spring mount position the spring member is deflected a first deflection distance relative to a spring member at-rest position, and the musical string is spaced a first lever arm distance from the string mount, and at a second spring mount position the spring member is deflected a second deflection distance relative to the spring member at-rest position, and the musical string is spaced a second lever arm distance from the string mount.

4. The string tensioner of claim 2, wherein at the first spring mount position the string is held at a first tension and at the second spring mount position the string is held at a second tension, and wherein the note emitted by the musical string at the first tension is within 10 cents of the note emitted by the musical string at the second tension.

5. The string tensioner of claim 3, wherein the note emitted by the musical string at the first tension is within 5 cents of the note emitted by the musical string at the second tension.

6. The string tensioner of claim 3, wherein the note emitted by the musical string at the first tension is within 10 cents of the note emitted by the musical string at the second tension.

7. The string tensioner of claim 1, wherein the tensioner body comprises a string path cavity aligned with the corresponding string mount, the string path cavity configured to accept the musical string extending therethrough.

8. The string tensioner of claim 1, additionally comprising a bridge assembly, the bridge assembly comprising:
a saddle body having a string receiver configured to receive a musical string, the saddle body having a pivot edge defined generally opposite the string receiver;
a base configured to receive the pivot edge so that the saddle body can pivot relative to the base when the pivot edge is engaged with the base;
a retainer member attached to one of the saddle body and the base; and
a passage formed in the other of the saddle body and the base, the retainer member extending through the passage;
wherein the saddle body and the base are configured so that when the pivot edge is engaged with the base, the retainer member does not restrain pivoting of the saddle body relative to the base.

9. The bridge assembly of claim 8 additionally comprising a blocking surface at or adjacent the passage, wherein the saddle body and the base are configured so that when the saddle body is moved a clearance distance away from the base the retainer member engages the blocking surface in a manner so that the saddle body is blocked from moving farther away from the base.

10. A string tensioner for a stringed musical instrument, comprising:
a tensioner body having a support member;
a cantilever mount structure attached to the support member in a manner so that the cantilever mount structure is rotatable about the support member, the cantilever mount structure configured to receive and support a first end of an elongated leaf spring member in a manner so that the elongated leaf spring member extends from the cantilever mount structure; and
a rotation limitation assembly configured to engage the cantilever mount structure in a manner so that rotation of the cantilever mount structure about the support member is limited to within an angular range.

11. The string tensioner of claim 10, wherein the support member comprises a cylindrical rod and the cantilever mount structure comprises a bore sized to accommodate the rod, and wherein the rod extends through the bore so that the cantilever mount structure rotates about the cylindrical rod.

12. The string tensioner of claim 11, wherein the cantilever mount structure comprises a beam support surface configured so that the first end of the leaf spring member can rest thereon and a fastener configured to secure the first end of the leaf spring onto the beam support surface.

13. The string tensioner of claim 11, wherein the tensioner body comprises a cross member having a plurality of spaced-apart threaded tensioner bosses and the cantilever mount structure comprises a tensioner receiver, and an elongated threaded tensioner extends through the tensioner receiver and into the tensioner boss.

14. The string tensioner of claim 13, configured so that advancing the tensioner into the tensioner boss reduces a range of rotation of the cantilever mount structure relative to the support member.

15. The string tensioner of claim 13, wherein the cantilever mount structure has a longitudinal axis, and the tensioner receiver is spaced from the longitudinal axis.

16. The string tensioner of claim 13, wherein a spring path is defined in a plane passing through the longitudinal axis of the cantilever mount structure, and wherein the tensioner boss is spaced from the string path.

17. The string tensioner of claim 15, additionally comprising a bridge assembly having a saddle, the saddle defining a string receiver aligned with the string path.
